(19) United States
(12) Patent Application Publication
(10) Pub. No.: US 2022/0281729 A1
(43) Pub. Date: Sep. 8, 2022

(54) FORKLIFT REACH MECHANISM AND FORKLIFT INCLUDING THE SAME

(71) Applicant: MITSUBISHI HEAVY INDUSTRIES, LTD., Tokyo (JP)

(72) Inventors: Megumu TSURUTA, Tokyo (JP); Keitaro KAMATA, Tokyo (JP); Tetsuhei KOBAYASHI, Tokyo (JP); Kensuke FUTAHASHI, Tokyo (JP); Tatsuya SATO, Tokyo (JP); Naoto KAWAUCHI, Tokyo (JP)

(21) Appl. No.: 17/586,125

(22) Filed: Jan. 27, 2022

(30) Foreign Application Priority Data
Mar. 8, 2021 (JP) 2021-036407

(51) Int. Cl. B66F 9/12

(52) U.S. Cl. CPC B66F 9/122

(57) ABSTRACT

A coupling portion that is coupled to a mast that supports a fork and has a mechanism that moves the fork in a vertical direction, the coupling portion disposed on each of both ends in a width direction of the mast, a rail that is disposed on a straddle leg disposed on an outside in the width direction of the mast and extending in a direction where the fork extends, the rail moving the coupling portion in the direction where the fork extends, and a drive unit that is disposed on the straddle leg and moves the mast along the straddle leg are included.

### CROSS-REFERENCE TO RELATED APPLICATIONS

This application claims the benefit of priority to Japanese Patent Application Number 2021-036407 filed on Mar. 8, 2021. The entire contents of the above-identified application are hereby incorporated by reference.

### TECHNICAL FIELD

The disclosure relates to a forklift reach mechanism and a forklift including the same.

### RELATED ART

There is a forklift that drives two plate-like forks to carry a cargo. The forklift moves the forks in the up-down direction and the front-rear direction. Some forklifts have a mechanism to move the fork in the left-right direction.

A reach mechanism in which the forklift moves the fork in the front-rear direction includes the device described in JP 2016-44038 A. JP 2016-44038 A describes a reach type forklift that includes a pair of left and right straddle legs provided in a front portion of a vehicle, a mast provided to be movable in a front-rear direction of the vehicle along the straddle legs, a fork provided to be liftable in the front portion of the mast, and an electric reach cylinder that moves the mast in a predetermined reach stroke.

### SUMMARY

In the forklift described in JP 2016-44038 A, the reach cylinder, which is a drive source that moves the fork in the front-rear direction, is disposed on the rear side of the mast, that is, on the opposite side to the fork with the mast interposed therebetween. On the rear side of the mast, a space is necessary depending on the amount of fork to be pushed out. Thus, there is a limitation in downsizing of the size of the vehicle body of the forklift, specifically, a length in the front-rear direction.

The present disclosure solves the problem described above and an object of the present disclosure is to provide a forklift reach mechanism that can downsize the structure of a forklift and a forklift having the same.

In order to solve the problem described above and achieve the object, the forklift reach mechanism according to the present disclosure includes a coupling portion that is coupled to a mast that supports a fork and has a mechanism that moves the fork in a vertical direction, the coupling portion disposed on each of both ends in a width direction of the mast, a rail that is disposed on a straddle leg disposed on an outside in the width direction of the mast and extending in a direction where the fork extends, the rail moving the coupling portion in the direction where the fork extends, and a drive unit that is disposed on the straddle leg and moves the mast along the straddle leg.

In order to solve the problem described above and achieve the object, the forklift according to the present disclosure includes the forklift reach mechanism according to any of the above, the vehicle body, and the mast.

According to the present disclosure, it is possible to downsize the structure of a forklift.

### BRIEF DESCRIPTION OF DRAWINGS

The disclosure will be described with reference to the accompanying drawings, wherein like numbers reference like elements.

FIG. 1 is a schematic view of a configuration of a forklift.

FIG. 2 is a schematic view illustrating a configuration of a reach mechanism with a schematic structure of a vehicle body.

FIG. 3 is an enlarged perspective view of a periphery of a lift bracket of FIG. 2.

FIG. 4 is a front view of FIG. 2.

FIG. 5 is a top view of FIG. 2.

FIG. 6 is a top view illustrating a structure of a coupling portion of another embodiment.

FIG. 7 is an enlarged view of the coupling portion of FIG. 6.

FIG. 8 is a schematic view illustrating a structure of a drive unit of another embodiment.

FIG. 9 is an explanatory diagram explaining an operation of the drive unit of FIG. 8.

### DESCRIPTION OF EMBODIMENTS

Preferred embodiments of the disclosure will be described in detail below with reference to the accompanying drawings. Note that the disclosure is not limited to these embodiments, and, when there are a plurality of embodiments, the disclosure is intended to include a configuration combining these embodiments.

### Forklift

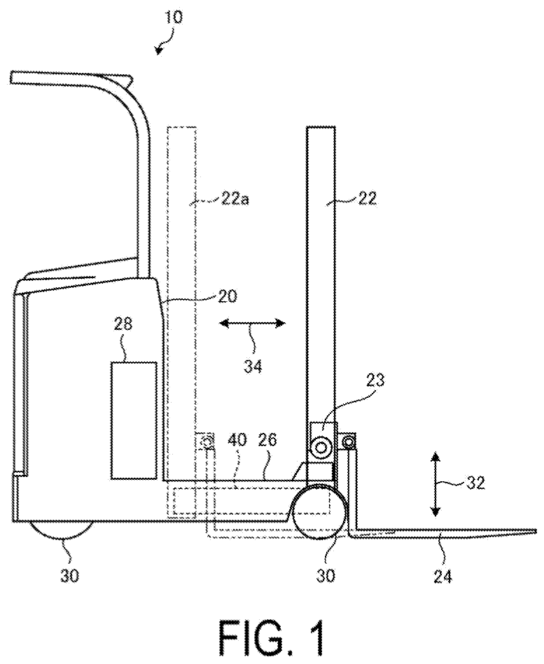

FIG. 1 is a schematic view of the configuration of a forklift. A forklift 10 according to the present embodiment is a movable device. The forklift 10 may be a so-called automated guided forklift (AGF) or may be a forklift operated by an operator.

As illustrated in FIG. 1, the forklift 10 includes a vehicle body 20, a mast 22, a lift bracket 23, a fork 24, a straddle leg 26, a mast support 27, a control device 28, a wheel 30, and a reach mechanism 40. In addition to the configuration described above, the forklift 10 includes various mechanisms provided in a forklift. The control device 28 controls the operation of the forklift 10. The control device 28 is a computer, and includes a communication unit, a storage unit, and a control unit. The communication unit is a communication module that is used in the control unit, communicates with an external device, and may include, for example, an antenna. In the present embodiment, the communication system by the communication unit is wireless communication. However, the communication system may be discretionary. The storage unit is a memory that stores various types of information such as the arithmetic content of the control unit and a program, and includes at least one of a main storage device such as a random access memory (RAM) and a read only memory (ROM) and an external storage device such as a hard disk drive (HDD). The control unit is an arithmetic device, and includes an arithmetic circuit such as a central processing unit (CPU). By reading a program (software) from the storage unit and executing it, the control unit implements the control operations of the forklift, and executes the processing of them. The control unit may execute such processing with a single CPU, or may include a plurality of CPUs and execute the processing with the plurality of CPUs.

The wheel 30 is disposed in the vehicle body 20 and the straddle leg 26 fixed to the vehicle body 20. The wheel 30 includes a wheel that drives, a wheel that steers, a wheel that is driven, and the like. The function of the wheel of each unit is not particularly limited.

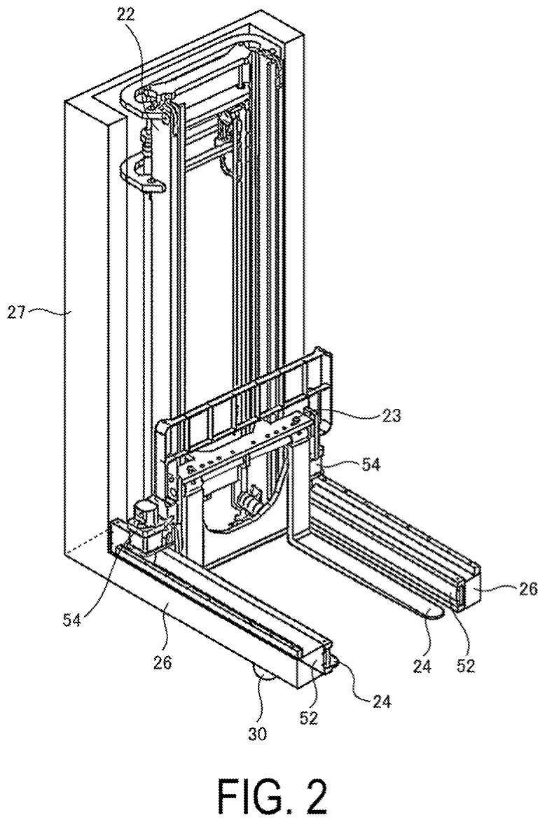

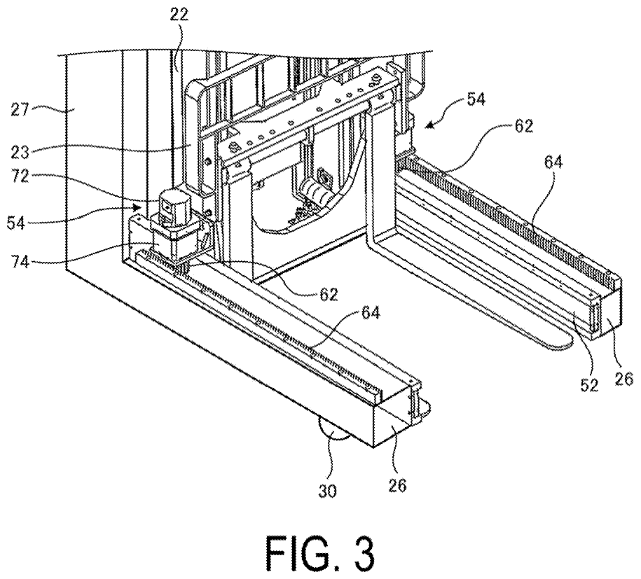

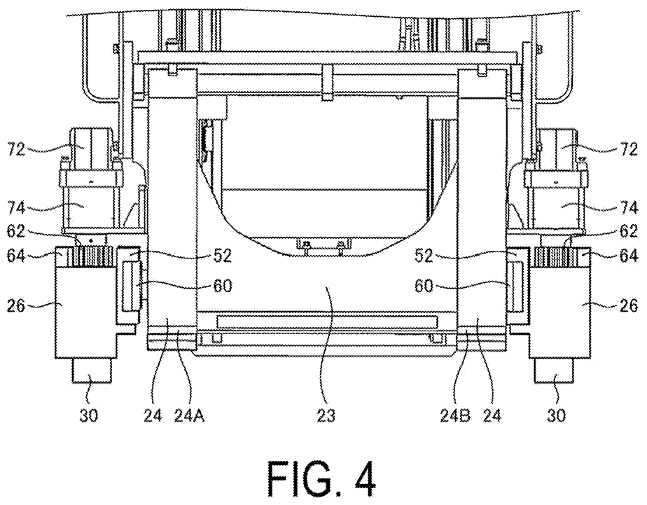

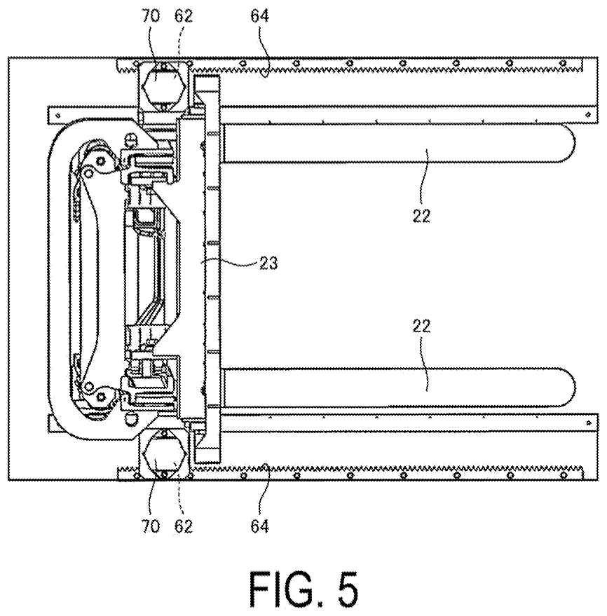

Next, the structure of the forklift, in particular, the drive mechanism of the fork 24, will be described with reference to FIGS. 2 to 5 in addition to FIG. 1. FIG. 2 is a schematic view illustrating the configuration of the reach mechanism with a schematic structure of the vehicle body. FIG. 3 is an enlarged perspective view of the periphery of a lift bracket of FIG. 2. FIG. 4 is a front view of FIG. 2. FIG. 5 is a top view of FIG. 2.

The forklift 10 holds a cargo by moving the fork 24 with respect to the vehicle body 20. The forklift 10 can move the fork 24 in an up-down direction 32 and a front-rear direction 34. The forklift 10 may be configured to be able to move the fork 24 (can side-shift) also in a lateral direction, which is a direction orthogonal to the up-down direction 32 and the front-rear direction 34. The up-down direction 32 is a vertical direction. The front-rear direction 34 is a direction of the horizontal direction in which tines 24A and 24B of the fork 24 extend. The tines 24A and 24B extend, from the mast 22, toward the front direction of the vehicle body 20. The tines 24A and 24B are arranged separated from each other in the lateral direction of the mast 22.

In the forklift 10, the straddle leg 26 is fixed to the vehicle body 20. The straddle leg 26 is provided at one end portion of the vehicle body 20 in the front-rear direction 34. The straddle leg 26 is a pair of shaft-like members that protrude in a direction where the fork 24 protrudes from the vehicle body 20. The straddle leg 26 is disposed outside relative to the fork 24 in the lateral direction.

The forklift 10 includes the mast support 27 that supports the mast 22 on a portion where the vehicle body 20 and the straddle leg 26 are connected. The mast support 27 is a structure fixed to both the vehicle body 20 and the straddle leg 26, and extends in the vertical direction. The mast support 27 is disposed on the vehicle body 20 side of the mast 22. The mast support 27 houses a part of the mast 22 in a state where the mast 22 is disposed on an end portion of the vehicle body 20 side.

Next, a mechanism that moves the fork 24 will be described. The lift bracket 23 is a structure that supports two forks 24. The lift bracket 23 is moved in the up-down direction 32 by the mast 22. By moving the lift bracket 23 in the up-down direction 32, the mast 22 moves the fork 24 in the up-down direction. The mast 22 includes a rail that guides the lift bracket 23 in the up-down direction 32, and a movement mechanism that moves the lift bracket 23 in the up-down direction. The movement mechanism is not particularly limited. A rack and pinion mechanism, a wire and a rotation mechanism that winds the wire, or the like can be used. It is possible to use a telescopic configuration in which, for example, the mast 22 includes a plurality of stages, the outer mast of the first stage from the top and the inner mast of the second stage are linearly moved by a hydraulic cylinder, and the lift bracket 23, which is the third stage and supports the mast 22, is driven by a chain.

The reach mechanism 40 is a mechanism that moves the fork 24 in the front-rear direction 34. The reach mechanism 40 is disposed between the vehicle body 20 and the mast 22, and moves the fork 24 in the front-rear direction 34 by moving the mast 22 in the front-rear direction 34. That is, the reach mechanism 40 moves, in the front-rear direction 34, the mast 22, the lift bracket 23, and the fork 24 as a unit with respect to the straddle leg 26 and the mast support 27 illustrated in FIG. 2. The reach mechanism 40 of the present embodiment is disposed between the straddle leg 26 and the mast 22, and moves the fork 24 in the front-rear direction 34 by moving the mast 22 along the straddle leg 26.

The reach mechanism 40 includes a coupling portion 50, a rail 52, and a drive unit 54. The coupling portion 50, the rail 52, and the drive unit 54 are disposed corresponding to each of the two straddle legs 26. The coupling portion 50, the rail 52, and the drive unit 54 of one side will be described now.

The coupling portion 50 is a structure that is fixed to the lateral end portion of the mast 22 and moves along the rail 52. The coupling portion 50 is a roller 60 supported by the lift bracket 23 in a rotatable state. The roller 60 is fixed in an orientation where the horizontal direction is the rotation axis and in an orientation where the roller 60 rotates in the front-rear direction.

The rail 52 is disposed on the inner side surface of the straddle leg 26, that is, a surface facing the other straddle leg 26. The rail 52 extends in the front-rear direction. The rail 52 is fixed to the straddle leg 26, protrusion portions protruding in the lateral direction are formed on the upper side and the lower side in the vertical direction, and a surface of the other straddle leg 26 is opened, having a structure in which one side in a rectangular cross section is absent. In the rail 52, the roller 60 is disposed between the protrusion portions protruding in the lateral direction on the upper side and the lower side in the vertical direction. The protrusion portion on the lower side in the vertical direction of the rail 52 and the roller 60 come into contact with each other, so that the roller 60 moves in the front-rear direction.

The drive unit 54 moves the fork 24 in the front-rear direction by moving the mast 22 in the front-rear direction with respect to the straddle leg 26 and the vehicle body 20. By operating based on the control of the control device 28, the drive unit 54 controls a position in the front-rear direction of the fork 24. The drive unit 54 includes a pinion gear 62, a rack 64, and a drive source 70.

The pinion gear 62 is disposed on the upper surface in the vertical direction of the straddle leg 26. The pinion gear 62 is coupled to a drive shaft of the drive source 70 fixed to the lift bracket 23 and is rotated by the drive source 70.

The rack 64 is disposed on the upper surface in the vertical direction of the straddle leg 26. The rack 64 is disposed extending in a direction where the straddle leg 26 extends, and a linear gear groove is formed in a surface facing the other straddle leg 26. In the rack 64, the pinion gear 62 is meshed with the gear groove to form a rack and pinion mechanism. That is, the pinion gear 62 rotates to move along the gear groove formed in the front-rear direction 34 of the rack 64, in other words, in a direction where the straddle leg 26 extends.

The drive source 70 is fixed to the lift bracket 23 and disposed on the upper surface in the vertical direction of the straddle leg 26. The drive source 70 rotates the pinion gear 62. The drive source 70 includes a hydraulic motor 72 and a reducer 74. The hydraulic motor 72 is a motor connected to a hydraulic circuit and driven by the pressure of a supplied hydraulic oil. The reducer 74 is disposed between the hydraulic motor 72 and the pinion gear 62, and by reducing the rotation of the hydraulic motor 72 and transmitting it to the pinion gear 62, the reducer 74 increases the torque that rotates the pinion gear 62. The reduction ratio of the reducer 74 is not particularly limited. Furthermore, the configuration of the drive source 70 is an example, and an electric motor may be used in place of the hydraulic motor.

By the drive unit 54 rotating the pinion gear 62, the reach mechanism 40 can apply, to the lift bracket 23, a force that moves the lift bracket 23 in the front-rear direction from both ends in the lateral direction of the lift bracket 23, and can move the fork 24 in the front-rear direction. The reach mechanism 40 can stabilize the posture of the fork 24 by moving, along the rail 52, the roller 60 of the coupling portion 50 disposed at the lateral end portion of the mast 22.

### Effect

As described above, in the forklift 10 according to the present embodiment, by providing, between the straddle leg 26 and the mast 22, the mechanism that moves in the front-rear direction of the reach mechanism 40, it is possible to provide a mechanism that moves in the front-rear direction without providing a structure in a region on the rear side of the mast 22. It is possible to stably move the fork 24 by providing the coupling portion 50 that moves along the rail 52 and the rail 52 provided on the two straddle legs 26 provided at both lateral ends of the mast 22, and by guiding a movement in the front-rear direction from both lateral ends of the mast 22.

In the forklift 10 of the present embodiment, it is possible to dispose the drive source on the upper side in the vertical direction of the straddle leg 26 by configuring the drive unit to be a rack and pinion and setting the drive shaft of the drive source 70 fixed to the mast 22 to be in a vertical direction. This can suppress the mechanism from protruding on the rear side relative to the mast support 27 of the vehicle body 20. The arrangement of the reach mechanism 40 can suppress the forklift 10 from increasing in the front-rear direction.

With the coupling portion 50, the rail 52, and the drive unit 54 disposed corresponding to each of the two straddle legs 26, the forklift 10 of the present embodiment can apply a force to move in the front-rear direction from both lateral directions, and can suitably move in the front-rear direction of the fork 22.

### OTHER EMBODIMENTS

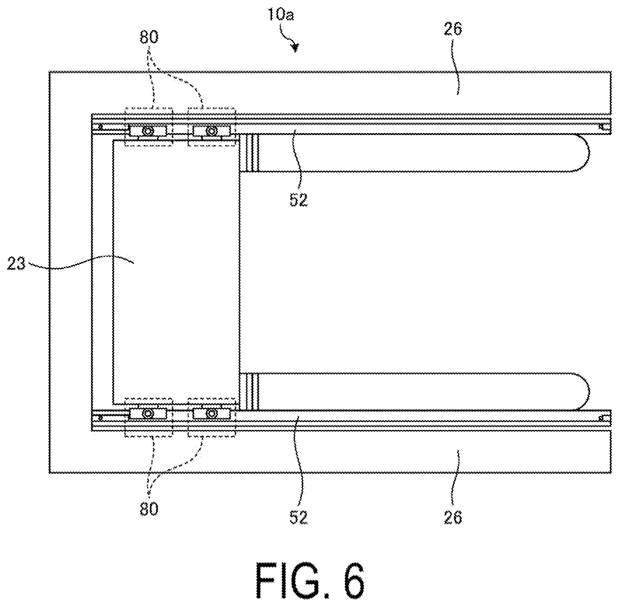

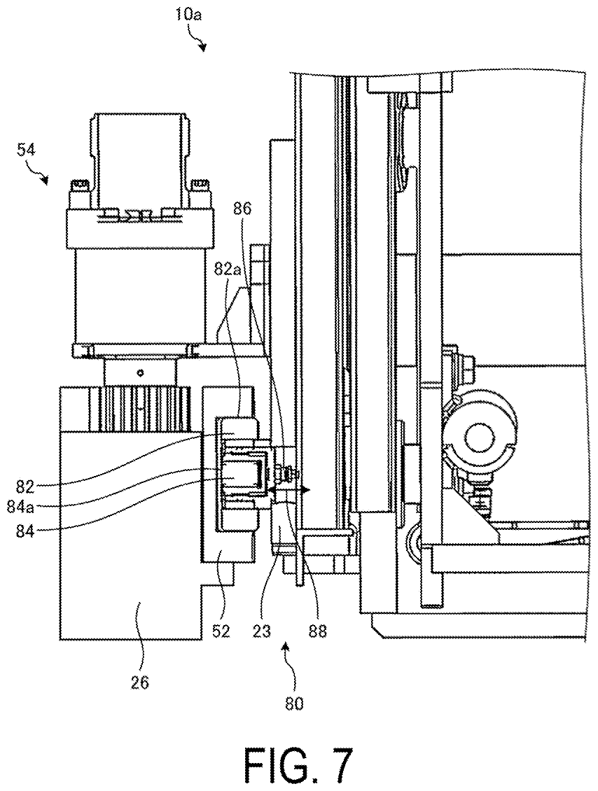

Next, other embodiments will be described. Parts of other embodiments that have configurations common to those in the present embodiment will not be described. FIG. 6 is a top view illustrating the structure of a coupling portion of another embodiment. FIG. 7 is an enlarged view of the coupling portion of FIG. 6.

The forklift illustrated in FIGS. 6 and 7 is similar to the forklift 10 except the structure of the coupling portion opposing the rail 52 of the reach mechanism. The coupling portion illustrated in FIGS. 6 and 7 includes two roller units 80 for one rail. That is, the reach mechanism of the present embodiment includes four roller units 80. The reach mechanism includes the roller units 80 at two points in the front-rear direction with respective to one rail 52. The roller units 80 are different in arrangement position and have the same structure. One roller unit 80 will be described below.

The roller unit 80 includes a roller 82, a side roller 84, and a pressing mechanism 86. The roller 82 is supported in a rotatable state by the lift bracket 23. The roller 82 is fixed in an orientation where the horizontal direction is the rotation axis and in an orientation where the roller 82 rotates in the front-rear direction. On the surface to rotate, the roller 82 comes into contact with a protrusion portion on the lower side in the vertical direction of the rail.

The side roller 84 is a roller with the vertical direction as the rotation axis. The side roller 84 is supported by the lift bracket 23 in a rotatable state. The side roller 84 faces a surface opposing the rail 52 facing the rail 52.

The pressing mechanism 86 is a structure, such as a spring, that applies a force in a predetermined direction. The pressing mechanism 86 is fixed to the lift bracket 23, and presses the side roller 84 toward the rail 52.

By the side roller provided as a coupling portion and the pressing mechanism 86 pressing the side roller against the rail 52, the forklift can suppress lateral variation of the fork 22, and can suppress the fork 22 from rotating with the vertical direction as an axis. That is, it is possible to guide the fork 22 smoothly in the front-rear direction. In addition, it is possible to stably hold the coupling portion inside the rail.

By the plurality of roller units provided in the front-rear direction as a coupling portion and having a plurality of support points in the front-rear direction, the forklift can suppress the fork 22 from rotating with the vertical direction as an axis. That is, it is possible to guide the fork 22 smoothly in the front-rear direction. In addition, it is possible to stably hold the coupling portion inside the rail.

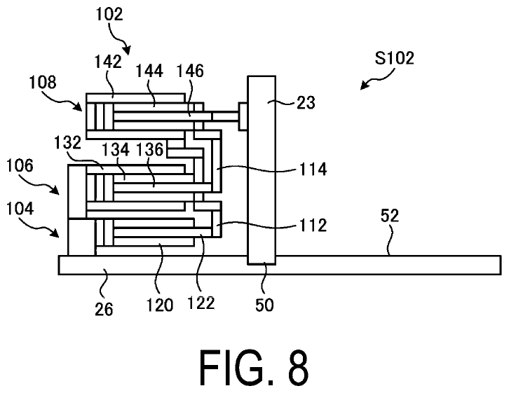

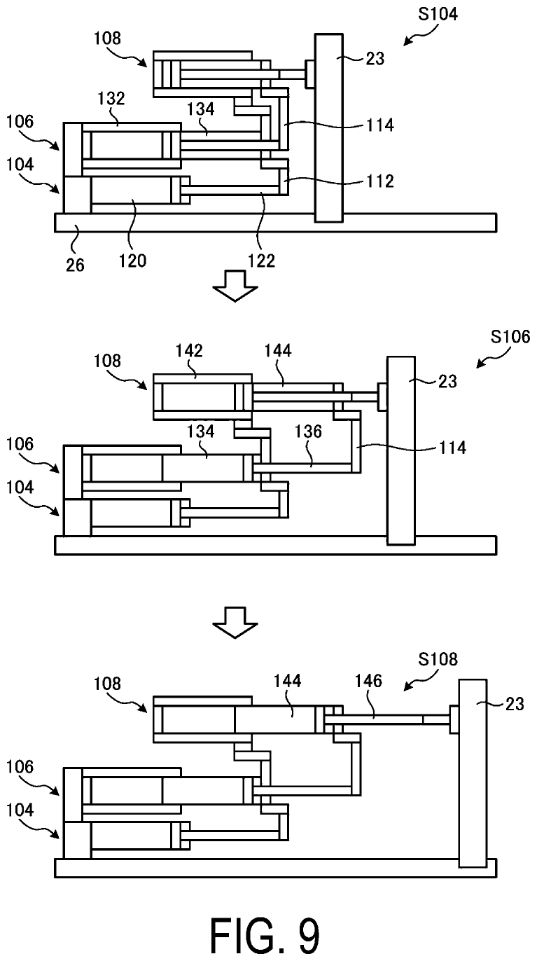

FIG. 8 is a schematic view illustrating the structure of a drive unit of another embodiment. FIG. 9 is an explanatory diagram explaining the operation of the drive unit of FIG. 8. A forklift 10a illustrated in FIGS. 8 and 9 has a similar structure to that of the forklift 10 except the drive unit.

A drive unit 102 illustrated in FIG. 8 is disposed between the straddle leg 26 and the lift bracket 23, and moves the lift bracket 23 in the front-rear direction with respect to the straddle leg 26. In the drive unit 102, each of the straddle legs 26 is provided with the structure illustrated in FIG. 8. In the forklift 10a, the drive unit 102 may be provided in an orientation where FIG. 8 is a top view or may be provided in an orientation where FIG. 8 is a side view.

The drive unit 102 includes a cylinder 104, a telescopic cylinder 106, a telescopic cylinder 108, a coupling portion 112, and a coupling portion 114. As the driving force for the cylinder 104, the telescopic cylinder 106, and the telescopic cylinder 108, air or hydraulic oil may be used.

The cylinder 104 includes a cylinder body 120 and a piston 122. The cylinder body 120 is fixed to the straddle leg 26. By the driving force being supplied, the piston 122 moves in the front-rear direction with respect to the cylinder body 120.

The telescopic cylinder 106 includes an outer cylinder 130, an inner cylinder 132, and a piston 134. The outer cylinder 130 is fixed to the straddle leg 26. The inner cylinder 132 is housed in the outer cylinder 130. By the driving force being supplied, the inner cylinder 132 moves in the front-rear direction with respect to the outer cylinder 130. The piston 134 is housed in the inner cylinder 132. By the driving force being supplied, the piston 134 moves in the front-rear direction with respect to the inner cylinder 132.

The telescopic cylinder 108 includes an outer cylinder 140, an inner cylinder 142, and a piston 144. The outer cylinder 140 is coupled to the inner cylinder 132 via the coupling portion 112. The inner cylinder 142 is housed in the outer cylinder 140. By the driving force being supplied, the inner cylinder 142 moves in the front-rear direction with respect to the outer cylinder 140. The piston 144 is housed in the inner cylinder 142. By the driving force being supplied, the piston 144 moves in the front-rear direction with respect to the inner cylinder 142. The piston 144 is coupled to the lift bracket 23.

The coupling portion 112 couples the piston 122, the inner cylinder 132, and the outer cylinder 140, and integrally moves the piston 122, the inner cylinder 132, and the outer cylinder 140. The coupling portion 114 couples the piston 134 and the inner cylinder 142, and integrally moves the piston 134, the inner cylinder 142, and the outer cylinder 140.

Next, the operation of the drive unit 102 moving the lift bracket 23 in the front-rear direction will be described with reference to FIGS. 8 and 9. FIGS. 8 and 9 illustrate a case in which the lift bracket 23 moves from a position closest to the mast 22 to a position furthest to the mast 22 in a movable region. As illustrated in step S102, in the drive unit 102, in a state where all the pistons of the cylinder 104, the telescopic cylinder 106, and the telescopic cylinder 108 are housed in the cylinder, the lift bracket 23 is in a position close to the mast 22, that is, a state in which the fork 24 is disposed on the vehicle body 20 side.

Next, as illustrated in step S104, the drive unit 102 drives the cylinder 104 to move the piston 122 in the front direction (direction away from the vehicle body 20). With the piston 122 being moved, the inner cylinder 132 moves in the front direction with respective to the outer cylinder 130 of the telescopic cylinder 106 via the coupling portion 112, and the entirety of the telescopic cylinder 108 moves in the front direction. Due to this, the lift bracket 23 moves in the front direction.

Next, as illustrated in step S106, the drive unit 102 drives the piston 134 of the telescopic cylinder 106 to move the piston 134 in the front direction (direction away from the vehicle body 20) with respect to the inner cylinder 132. With the piston 134 being moved, the inner cylinder 142 moves in the front direction with respective to the outer cylinder 140 of the telescopic cylinder 108 via the coupling portion 114. Due to this, the lift bracket 23 moves further in the front direction.

Next, as illustrated in step S108, the drive unit 102 drives the piston 144 of the telescopic cylinder 108 to move the piston 144 in the front direction (direction away from the vehicle body 20) with respect to the inner cylinder 142. Due to this, the lift bracket 23 moves further in the front direction.

By the plurality of telescopic cylinders thus provided and coupled by the coupling portion, in the forklift 10a, the drive unit, having a length in the front-rear direction shorter than a movement amount in the front-rear direction of the fork 24, can move a predetermined movement amount in the front-rear direction of the fork 24. This can suppress a size in the front-rear direction from increasing.

### Effect of Present Disclosure

As described above, the forklift reach mechanism (reach mechanism 40) of the present disclosure includes a coupling portion that is coupled to a mast that supports a fork and has a mechanism that moves the fork in a vertical direction, the coupling portion disposed on each of both ends in a width direction of the mast, a rail that is disposed on a straddle leg disposed on an outside in the width direction of the mast and extending in a direction where the fork extends, the rail moving the coupling portion in the direction where the fork extends, and a drive unit that is disposed on the straddle leg and moves the mast along the straddle leg. This can downsize the structure of the forklift.

The drive unit preferably includes a pinion gear coupled to the mast, a rack fixed to the straddle leg and coupled to the pinion gear, and a drive source that rotates the pinion gear. This can stably move the rail. Furthermore, the drive source can be made compact.

The drive source is preferably a hydraulic motor. This can further enhance the driving force of the rail.

In the coupling portion, it is preferable that the roller abutting against the rail and moving along the rail is disposed at a plurality of locations in the front and rear between the rail and the mast. This can suppress the rail from moving in the rotation direction.

It is preferable to provide the pressing mechanism that presses the roller from a side of the mast to a side of the rail. This can suppress the rail from moving in the rotation direction.

It is preferable that the drive unit includes a plurality of telescopic cylinders coupled to the straddle legs and the mast and extending in the direction where the fork extends, and a position of a piston of the telescopic cylinders is moved with a cylinder that is coupled. The drive source can be made compact.

The forklift of the present disclosure includes the forklift reach mechanism according to any of the above, the fork, and the mast. The forklift can be made compact.

The embodiment of the disclosure is described above, but the embodiment is not limited by the details of the embodiment above. Further, the constituent elements of the above-described embodiment include elements that are able to be easily conceived by a person skilled in the art, and elements that are substantially the same, that is, elements of an equivalent scope. Furthermore, the constituent elements described above can be appropriately combined. Further, it is possible to make various omissions, substitutions, and changes to the constituent elements within a range not departing from the scope of the above-described embodiment.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A forklift reach mechanism comprising:
a coupling portion that is coupled to a mast that supports a fork and has a mechanism that moves the fork in a vertical direction, the coupling portion disposed on each of both ends in a width direction of the mast;
a rail that is disposed on a straddle leg disposed on an outside in the width direction of the mast and extending in a direction where the fork extends, the rail moving the coupling portion in the direction where the fork extends; and
a drive unit that is disposed on the straddle leg and moves the mast along the straddle leg.

2. The forklift reach mechanism according to claim 1, wherein the drive unit comprises:
a pinion gear coupled to the mast,
a rack fixed to the straddle leg and coupled to the pinion gear, and
a drive source that rotates the pinion gear.

3. The forklift reach mechanism according to claim 2, wherein the drive source is a hydraulic motor.

4. The forklift reach mechanism according to claim 1, wherein, in the coupling portion, a roller abutting against the rail and moving along the rail is disposed at a plurality of locations in the front and rear between the rail and the mast.

5. The forklift reach mechanism according to claim 4, further comprising a pressing mechanism that presses the roller from a side of the mast to a side of the rail.

6. The forklift reach mechanism according to claim 1, wherein
the drive unit comprises a plurality of telescopic cylinders coupled to the straddle legs and the mast and extending in the direction where the fork extends, and
a position of a piston of the telescopic cylinders is moved with a cylinder that is coupled.

7. A forklift comprising:
the forklift reach mechanism described in claim 1;
the fork; and
the mast.
